(19) United States
(12) Patent Application Publication
(10) Pub. No.: US 2015/0067050 A1
(43) Pub. Date: Mar. 5, 2015

(54) METHOD AND SYSTEM FOR SOCIAL NETWORKING IN A MULTI-SCREEN ENVIRONMENT

(71) Applicants: Jae Ho KIM, Nonsan-si (KR); Ju Il JEON, Cheongju-si (KR); Chang Ki KIM, Daejeon (KR); Tae Jung KIM, Cheongju-si (KR); Jeong Ju YOO, Daejeon (KR)

(72) Inventors: Jae Ho KIM, Nonsan-si (KR); Ju Il JEON, Cheongju-si (KR); Chang Ki KIM, Daejeon (KR); Tae Jung KIM, Cheongju-si (KR); Jeong Ju YOO, Daejeon (KR)

(73) Assignee: ELECTRONICS AND TELECOMMUNICATONS RESEARCH INSTITUTE, Daejeon-si (KR)

(21) Appl. No.: 14/101,563

(22) Filed: Dec. 10, 2013

(30) Foreign Application Priority Data
Sep. 3, 2013 (KR) 10-2013-0105409

(51) Int. Cl. H04L 29/08

(52) U.S. Cl. CPC H04L 67/10
USPC 709/204

(57) ABSTRACT

Disclosed is a social network service device. The social network service device includes a message processing unit which receives, from a common smart device, an identifier of a user group which uses the common smart device, and information of a personal smart device which is connected to the common smart device for a multi-screen service, and a social network establishment unit which establishes a social network between common smart devices by modeling a relation between the user group and a user who uses the personal smart device, and a relation between the common smart device and the personal smart device, using the information of the personal smart device, based on the identifier of the user group.

Priority to Korean patent application number 2013-0105409 filed on Sep. 3, 2013, the entire disclosure of which is incorporated by reference herein, is claimed.

### BACKGROUND OF THE INVENTION

1. Field of the Invention

The present invention relates to a method and system for establishing a social network between smart devices for a multi-screen service.

2. Discussion of the Related Art

Recently, a social network service (SNS) is being actively used through a personal computer (PC), a smart device, etc. The smart device is a device which is connected Internet through a wired/wireless network, thus has a web-browsing function, and has a computing function. Some examples of the smart device are a smartphone, a smart pad, and a smart television (TV).

The SNS is a service which allows users to form a social network on the web based on social relationship between the users. Generally, a social network is established based on user's profile information or contact information which is inputted when users join the social network.

As one of technologies about the SNS, Korean Patent No. 10-1232229 (registered on Feb. 5, 2013) “Phone number based social network service system and method” discloses a social network service based on a phone number, which allows a user to conveniently use the social network service as if the user sent a text message.

Furthermore, recently, as smart devices are widely distributed, more and more users are using contents and services using a plurality of smart devices at the same time based on a multi-screen technology. The multi-screen refers to a screen set of a plurality of smart devices owned by a user, and the multi-screen service refers to providing contents and services to the user through two or more screens. For example, the user may use contents and services related with a program being viewed through a smart TV using a smart device held by the user while watching the smart TV based on the multi-screen technology.

However, the conventional multi-screen service is usually an indoor service through connection between the smart TV and the personal smart device. Hence, there is a need for a method of extending the range of the conventional multi-screen service by establishing a social network between smart devices.

### SUMMARY OF THE INVENTION

An object of the present invention is to provide a method and system for establishing a multi-screen social network capable of extending the range of providing the conventional multi-screen service in family or group units.

In accordance with an aspect of the present invention, a social network service device includes a message processing unit which receives, from a common smart device, an identifier of a user group which uses the common smart device, and information of a personal smart device which is connected to the common smart device for a multi-screen service, and a social network establishment unit which establishes a social network between common smart devices by modeling a relation between the user group and a user who uses the personal smart device, and a relation between the common smart device and the personal smart device, using the information of the personal smart device, based on the identifier of the user group.

The common smart device may be connected to a personal smart device which is discovered through at least one of protocols such as universal plug and play (UPnP), Bonjour, multicast domain name system (mDNS), and WebIntent.

The information of the personal smart device may include an identifier of a user who uses the personal smart device, an identifier of the personal smart device, and acquaintance information of the user.

The acquaintance information may include contact information stored in the personal smart device, and acquaintance information of a social network in which the user has been registered as a member.

The social network establishment unit may model a relation between the user group and the user, and a relation between the common smart device and the personal smart device, by associating the identifier of the user group associated with the common smart device with the identifier of the user associated with the identifier of the personal smart device, and may establish a social network between the common smart devices using acquaintance information of each user and information which has been modeled in respective user group units.

The social network service may further include a member information processing unit which collects, manages, and processes member information of the social network by registering the identifier of the user group and the identifier of the common smart device which have been received from the common smart device.

The social network service device may further include a multi-screen state management unit which manages a state of a multi-screen between the personal smart device and the common smart device by periodically examining an on/offline state and network address of the personal smart device.

In accordance with another aspect of the present invention, a method of establishing a social network by a social network service device includes receiving, from a common smart device, an identifier of a user group which uses the common smart device, and information of a personal smart device which is connected to the common smart device for a multi-screen service, and establishing a social network between common smart devices by modeling a relation between the user group and a user who uses the personal smart device, and a relation between the common smart device and the personal smart device, using the information of the personal smart device, based on the identifier of the user group.

In accordance with yet another aspect of the present invention, a smart device includes a discover unit which discovers a smart device for a multi-screen service, a management unit which registers a user of the smart device as a member of the user group, based on an identifier of the user of the smart device and an identifier of the smart device, which have been received from the smart device, and a processing unit which transmits an identifier of the user group and information received from the smart device, to a social network service device in order to establish a social network, wherein the social network is established by modeling a relation between the user group and the user and a relation between the smart devices, using the information of the smart device, based on the identifier of the user group.

### BRIEF DESCRIPTION OF THE DRAWINGS

FIG. 1 illustrates a case where a multi-screen service is provided through a smart TV and a smart device in an indoor place;

FIG. 2 illustrates a method of establishing a social between smart devices, according to an embodiment of the present invention;

FIG. 3 is a block diagram illustrating a system for establishing a multi-screen social networks system, according to an embodiment of the present invention;

FIG. 4 illustrates relationship between a group identifier and a user identifier and relationship between devices identifiers related with the group and the user; and

FIG. 5 is a flowchart illustrating a method of establishing a multi-screen social network, according to an embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art.

Hereinafter, some embodiments of the present invention are described in detail with reference to the accompanying drawings in order for a person having ordinary skill in the art to which the present invention pertains to be able to readily implement the invention. It is to be noted the present invention may be implemented in various ways and is not limited to the following embodiments. Furthermore, in the drawings, parts not related to the present invention are omitted in order to clarify the present invention and the same or similar reference numerals are used to denote the same or similar elements.

The objects and effects of the present invention can be naturally understood or become clear by the following description, and the objects and effects of the present invention are not restricted by the following description only.

The objects, characteristics, and merits will become more apparent from the following detailed description. Furthermore, in describing the present invention, a detailed description of a known art related to the present invention will be omitted if it is deemed to make the gist of the present invention unnecessarily vague. A preferred embodiment in accordance with the present invention is described in detail below with reference to the accompanying drawings.

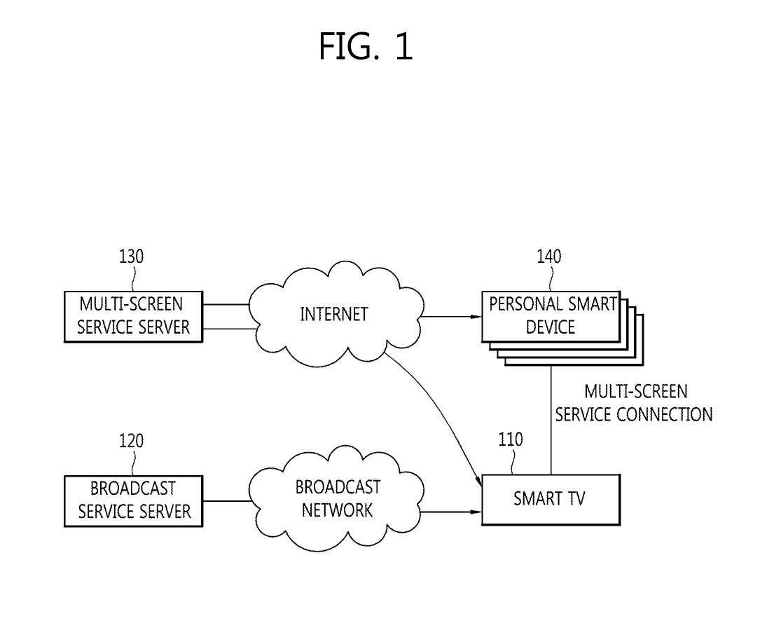

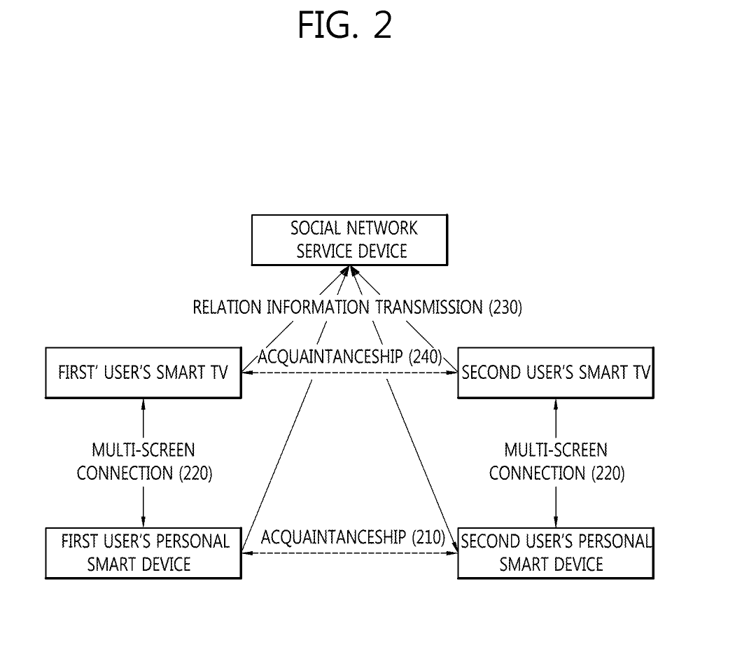

FIG. 1 illustrates a case where a multi-screen service is provided through a smart TV and a smart device in an indoor place, and FIG. 2 illustrates a method of establishing a social between smart devices, according to an embodiment of the present invention.

Hereinafter, a case where a user is provided a multi-screen service through a smart TV and a personal smart device in an indoor place will be described.

In an indoor place, the smart TV 110 is a device which is commonly used by family members, and is connected to a broadcast network and Internet. One way broadcast content from the broadcast service server 120 is transmitted to the smart TV 100 through a broadcast network such as a terrestrial, cable, and satellite, and the additional content and service related to the broadcast content are transmitted to the smart TV 100 through Internet. At this time, the additional content and service may be transmitted to the smart TV 110 or a personal smart device 140 of a family member by the multi-screen service server 130.

Likewise, the multi-screen service is a service which simultaneously utilizes the smart TV 110 and the personal smart device 140. However, the conventional multi-screen service is usually a service through a connection between the smart TV 110 and the personal smart device 140 of a family member in an indoor place. Hence, the multi-screen social network establishment system according to the present invention may extend the range of the multi-screen service, which has been limited to the indoor place, to allow a multi-screen service between families and groups by establishing a multi-screen social network, that is, a social network between common smart devices such as the smart TV 110.

For example, FIG. 2 illustrates a case where a first user is acquainted with a second user. The acquaintanceship 210 between the personal smart device of the first user and the personal smart device of the second user is established when the other person's contact information such as an e-mail address and a phone number is stored in the personal smart device of each user and when each user explicitly adds the other person as an acquaintance.

If the personal smart device is connected to the smart TV in an indoor place for a multi-screen service (220), each smart TV may register each user in the home group. In this case, the relationship between the personal smart device and the smart TV is also established.

The relation information between the home group and the user, and the relation information 230 between the smart TV and the personal smart device are transmitted to the social network service device. The social network service device may establish a social network between smart device by using the acquaintanceship between respective users based on the relation information between the home group and the user and the relation information 230 between the smart TV and the personal smart device, and provide the social network service.

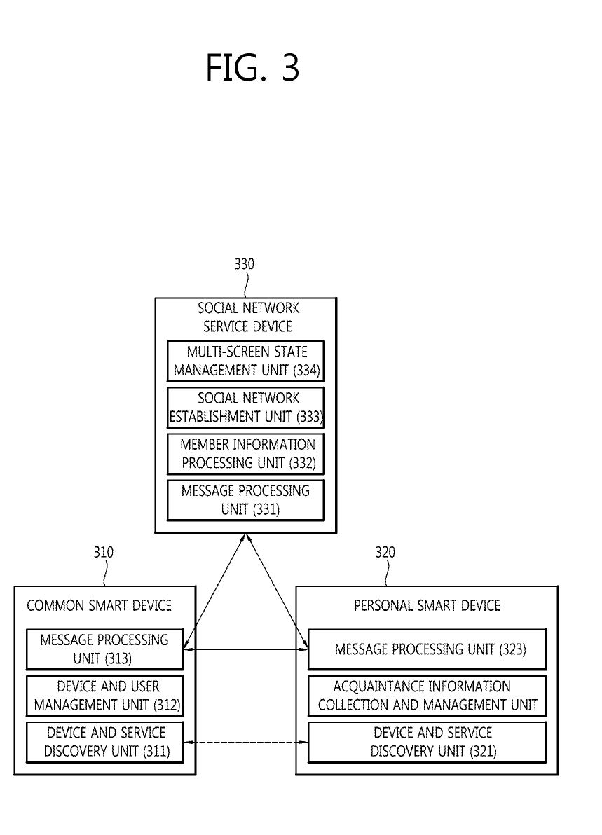

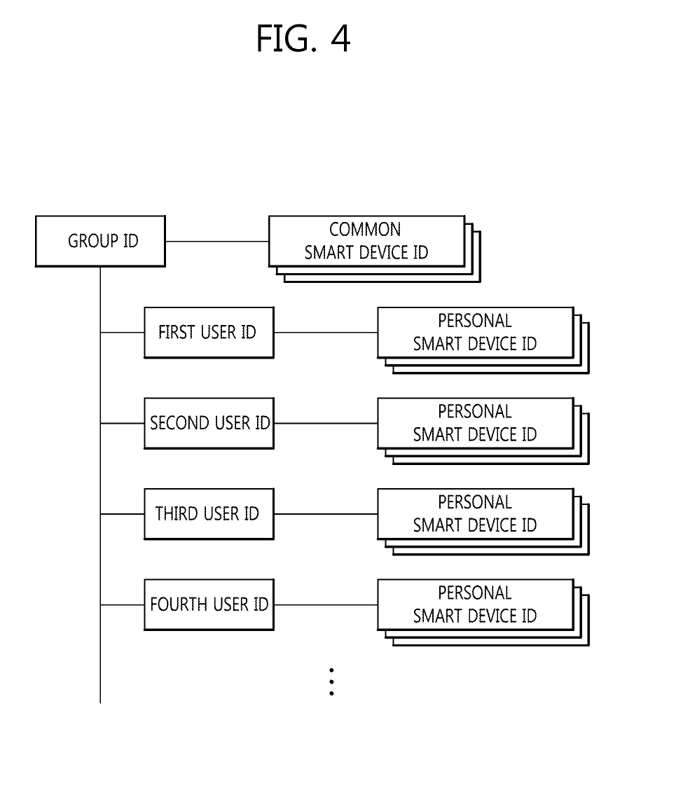

FIG. 3 is a block diagram illustrating a system for establishing a multi-screen social networks system, according to an embodiment of the present invention, and FIG. 4 illustrates relationship between a group identifier and a user identifier and relationship between devices identifiers related with the group and the user.

First, referring to FIG. 3, the multi-screen social network system according to the present invention includes a common smart device 310, a personal smart device 320, and a social network service device 330.

The common smart device 310 is a smart device which may be commonly used by a plurality of users, such as a smart TV, and may include a service discovery unit 311, a device and user management unit 312, and a message processing unit 313. Furthermore, the personal smart device 320 is a smart device which is personally used by a user, and may include a device and service discovery unit 321, an acquaintance information collection and management unit 322, and a message processing unit 313.

The common smart device 310 and the personal smart device 320 are automatically found and connected through the device and service discovery units 311 and 321. For example, the device and service discovery units 311 and 321 of the common smart device 310 and the personal smart device 320 may find a smart device for a multi-screen service by using at least one protocol among a universal plug and play (UPnP), Bonjour, a multicast domain name system (mDNS), and WebIntent.

The device and user management unit 312 of the common smart device 310 performs the function of registering the user of the personal smart device 420 connected for the multi-screen service, and the user thereof, as the group member, and managing the group member. For example, the device and user management unit 312 may register the user of the personal smart device 320 and the device as the member of the user group who uses the common smart device 310 by connecting the user ID and the ID of the personal smart device 320, which are received from the personal smart device 320, to the ID of the user group.

Furthermore, the acquaintance information collection and management unit 322 of the personal smart device 320 performs the function of collecting the phone number and e-mail information of an acquaintance of the personal smart device 320, and the acquaintance information of the existing social network, in which the user has been registered as a member, etc., and managing the collected information.

The message processing units 313 and 323 of the common smart device 310 and the personal smart device 320 perform a message communication function. For example, the message processing unit 313 of the common smart device 310 may transmit information, which is received from the personal smart device 320 for establishment of the social network between smart devices, to the social network service device 330 along with the identifier of the user group. Here, the information, which is received by the common smart device 310 from the personal smart device 320, may include the identifier of the user who uses the personal smart device 320, the identifier of the personal smart device, and acquaintance information of the user. At this time, the acquaintance information may include contact information stored in the personal smart device and the acquaintance information of the social network in which the user has been registered as a member.

Furthermore, the social network service device 330 may include a message processing unit 331, a member information processing unit 332, a social network establishment unit 333, a multi-screen state management unit 334.

The message processing unit 331 performs a message communication function with the common smart device 310 and the personal smart device 320. For example, the message processing unit 331 may receive, from the common smart device 310, information the identifier of the user group which uses the common smart device and the information of the personal smart device 320 which is connected to the common smart device 310 for the multi-screen service. The information of the personal smart device 320 may include the identifier of the user who uses the personal smart device 320, the identifier of the personal smart device 320, and the acquaintance information of the user. Here, the acquaintance information of the user may include contact information stored in the personal smart device 320 and the acquaintance information of the social network in which the user has been registered as a member. The identifier of the user and the acquaintance of the user may be directly transmitted from the personal smart device 320 to the social network service device 330. The message processing unit 331 may process control information of the transmitted and received message, and may transmit the parsed data to each function block.

The member information processing unit 332 may collect, manage, and process the member information on the multi-screen social network service by registering the identifier of the user group and the identifier of the common smart device 310, which are received from the common smart device 310.

The social network establishment unit 333 establishes a social network between common smart devices by modeling the relation the user group that uses the common smart device 310 and the personal smart device 320, and the relation between the common smart device 310 and the personal smart device 320 by using the information of the personal smart device 320 based on the identifier of the user group. For example, the social network establishment unit 333 may model the relation as in FIG. 4 by using the information received through the procedure of FIG. 2.

Referring to FIG. 4, the identifier (group ID) of the user group is an identifier which binds family members in an indoor multi-screen service environment, and is associated with the identifier (common smart device ID) of the device such as a smart TV which is commonly used by the family members. One or more common smart device IDs may be associated with one group ID. The users, which belong to the user group, may own their personal smart devices, respectively. The identifier of the personal smart device (ID of the personal smart device) is associated with the identifier of the user. Hence, the social network establishment unit 333 model the relation between the user group and the user and the relation between the common smart device 310 and the personal smart device 320 by associating the identifier of the user group associated with the identifier of the common smart device 310 with the identifier of the user associated with the identifier of the personal smart device 320, and may establish a social network between the common smart devices using acquaintance information of each user and information which is modeled in each user group unit.

The multi-screen state management unit 334 may manage the state of the multi-screen between the personal smart device 320 and the common smart device 310 by periodically examining the network address and on/offline state of the personal smart device 320.

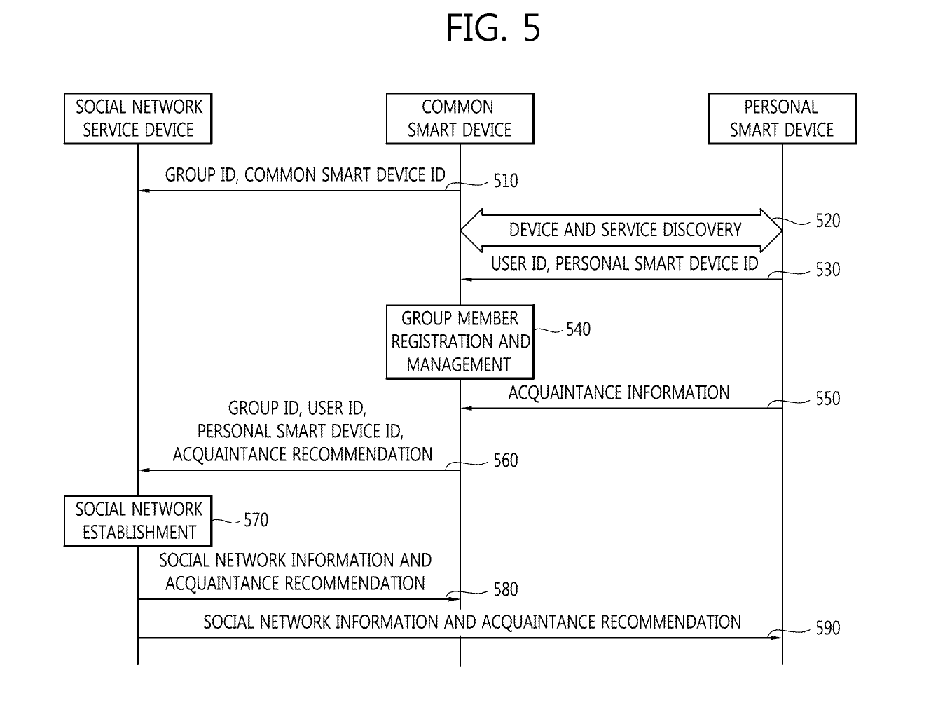

FIG. 5 is a flowchart illustrating a method of establishing a multi-screen social network, according to an embodiment of the present invention.

The user, who newly registers in the multi-screen social network service, may register a group ID, which represents the group, and the common smart device ID, which is commonly used by the family, in the social network service device. Here, the social network service device may register the group ID and the common smart ID which are received from the common smart device (510).

When the user uses the multi-screen service using the common smart device and the personal smart device, the common smart device and the personal smart device may perform a mutual device and service discovery using protocols such as a universal plug and play (UPnP), Bonjour, a multicast domain name system (mDNS), and WebIntent (520).

The initially discovered smart device transmits the user ID and the personal smart device ID to the common smart device (530), and the common smart device registers the user as a group member based on the user ID and the personal smart device ID and manages the group member (540).

If the personal smart device transmits the acquaintance information such as the a phone number and an e-mail address, which is stored in the local or the network, to the common smart device (550), the common smart device transmits the group ID, the user ID which belongs to the group, the personal smart device ID, and the acquaintance information of each user, to the social network service device (560). At this time, the user ID, which belongs to the group, and the acquaintance information of the user may be directly transmitted from the personal smart device to the social network service device.

The social network service device establishes the social network between common smart devices by modeling the relation between the user group who uses the common smart device and the user who uses the personal smart device, and the relation between the common smart device and the personal smart device, based on the information received from each smart device (570). Thereafter, the social network service device may transmit the multi-screen social network information and acquaintance recommendation message to each smart device based on the established social network (580 and 590). Each smart device may utilize the received multi-screen social network information acquaintance information to various multi-screen services.

According to one or more embodiments of the present invention, a social network between smart devices may be automatically established based on relationship between the smart devices in a multi-screen environment.

Furthermore, the range of providing the conventional multi-screen service may be extended to family units or group units by using the social network between smart devices, the user may find a smart device of an acquaintance, and the multi-screen service developer and provider may develop and provide various multi-screen services based on the social network between the smart devices.

A person having ordinary skill in the art to which the present invention pertains may change and modify the present invention in various ways without departing from the technical spirit of the present invention. Accordingly, the present invention is not limited to the above-described embodiments and the accompanying drawings.

In the above exemplary system, although the methods have been described based on the flowcharts in the form of a series of steps or blocks, the present invention is not limited to the sequence of the steps, and some of the steps may be performed in a different order from that of other steps or may be performed simultaneous to other steps. Furthermore, those skilled in the art will understand that the steps shown in the flowchart are not exclusive and the steps may include additional steps or that one or more steps in the flowchart may be deleted without affecting the scope of the present invention.

What is claimed is:

1. A social network service device comprising:
a message processing unit which receives, from a common smart device, an identifier of a user group which uses the common smart device, and information of a personal smart device which is connected to the common smart device for a multi-screen service; and
a social network establishment unit which establishes a social network between common smart devices by modeling a relation between the user group and a user who uses the personal smart device, and a relation between the common smart device and the personal smart device, using the information of the personal smart device, based on the identifier of the user group.

2. The social network service device of claim 1, wherein the common smart device is connected to a personal smart device which is discovered through at least one of protocols such as universal plug and play (UPnP), Bonjour, multicast domain name system (mDNS), and WebIntent.

3. The social network service device of claim 1, wherein the information of the personal smart device includes an identifier of a user who uses the personal smart device, an identifier of the personal smart device, and acquaintance information of the user.

4. The social network service device of claim 3, wherein the acquaintance information includes contact information stored in the personal smart device, and acquaintance information of a social network in which the user has been registered as a member.

5. The social network service device of claim 1, wherein the social network establishment unit models a relation between the user group and the user, and a relation between the common smart device and the personal smart device, by associating the identifier of the user group associated with the common smart device with the identifier of the user associated with the identifier of the personal smart device, and establishes a social network between the common smart devices using acquaintance information of each user and information which has been modeled in respective user group units.

6. The social network service of claim 1, further comprising:
a member information processing unit which collects, manages, and processes member information of the social network by registering the identifier of the user group and the identifier of the common smart device which have been received from the common smart device.

7. The social network service device of claim 1, further comprising:
a multi-screen state management unit which manages a state of a multi-screen between the personal smart device and the common smart device by periodically examining an on/offline state and network address of the personal smart device.

8. A method of establishing a social network by a social network service device, the method comprising:
receiving, from a common smart device, an identifier of a user group which uses the common smart device, and information of a personal smart device which is connected to the common smart device for a multi-screen service; and
establishing a social network between common smart devices by modeling a relation between the user group and a user who uses the personal smart device, and a relation between the common smart device and the personal smart device, using the information of the personal smart device, based on the identifier of the user group.

9. The method of claim 8, further comprising:
registering the identifier of the user group and the identifier of the common smart device which have been received from the common smart device.

10. The method of claim 8, wherein the common smart device is connected to a personal smart device which is discovered through at least one of protocols such as universal plug and play (UPnP), Bonjour, multicast domain name system (mDNS), and WebIntent.

11. The method of claim 8, wherein the information of the personal smart device includes an identifier of a user who uses the personal smart device, an identifier of the personal smart device, and acquaintance information of the user.

12. The method of claim 11, wherein the acquaintance information includes contact information stored in the personal smart device, and acquaintance information of a social network in which the user has been registered as a member.

13. The method of claim 8, wherein the establishing of the social network comprises:
modeling a relation between the user group and the user, and a relation between the common smart device and the personal smart device, by associating the identifier of the user group associated with the common smart device with the identifier of the user associated with the identifier of the personal smart device; and
establishing a social network between the common smart devices using acquaintance information of each user and information which has been modeled in respective user group units.

14. A smart device comprising:
a discover unit which discovers a smart device for a multi-screen service;
a management unit which registers a user of the smart device as a member of the user group, based on an identifier of the user of the smart device and an identifier of the smart device, which have been received from the smart device; and
a processing unit which transmits an identifier of the user group and information received from the smart device, to a social network service device in order to establish a social network,
wherein the social network is established by modeling a relation between the user group and the user and a relation between the smart devices, using the information of the smart device, based on the identifier of the user group.

15. The smart device of claim 14, wherein the discovery unit discovers the smart device using at least one of protocols such as universal plug and play (UPnP), Bonjour, multicast domain name system (mDNS), and WebIntent.

16. The smart device of claim 14, wherein the information of the smart device includes an identifier of a user who uses the smart device, an identifier of the smart device, and acquaintance information of the user.

17. The smart device of claim 16, wherein the acquaintance information includes contact information stored in the smart device, and acquaintance information of a social network in which the user has been registered as a member.
